(19) United States
(12) Patent Application Publication
(10) Pub. No.: US 2018/0149921 A1
(43) Pub. Date: May 31, 2018

(54) METHOD OF PRODUCING DISPLAY DEVICE, AND BACKLIGHT UNIT PACKAGE

(71) Applicant: SHARP KABUSHIKI KAISHA, Sakai City, Osaka (JP)

(72) Inventor: KATSUHIRO YAMAGUCHI, Sakai City (JP)

(21) Appl. No.: 15/573,749

(22) PCT Filed: May 18, 2016
(86) PCT No.: PCT/JP2016/064691

§ 371 Date: Nov. 13, 2017

(30) Foreign Application Priority Data
May 25, 2015 (JP) 2015-105457

(51) Int. Cl. G02F 1/1335; F21V 8/00

(52) U.S. Cl. CPC G02F 1/133603; G02F 1/133514; G02B 6/0011

(57) ABSTRACT

A method of producing a display device includes a fixing member placing process, a protective member bonding process, and a panel mounting process. The fixing member placing process includes placing elongated fixing members including first fixing surfaces and second fixing surfaces with longitudinal directions thereof along peripheral edges of a light exiting surface of the backlight unit and a gap between ends of the fixing members and bonding the first fixing surfaces to the peripheral edges. The protective member bonding process includes bonding the protective member to the second surfaces such that a peripheral edge of the protective member in a form of a canopy extends outward from the peripheral edge of the light exiting surface at least at a position corresponding to the gap between the fixing members. The panel mounting process includes removing the protective member and bonding the display panel to the second fixing surfaces.

### TECHNICAL FIELD

The present invention relates to a method of producing a display device, and a backlight unit package.

### BACKGROUND ART

Liquid crystal display devices including liquid crystal panels as display members for displaying images have been known. The liquid crystal panels do not have self-light-emitting functions and thus the liquid crystal display devices include backlight units for illuminating the liquid crystal panels with light from the back.

In a production process of Small-to-medium sized liquid crystal display devices among such liquid crystal display devices, the liquid crystal panels are attached to the backlight units. Patent Document 1 discloses bonding a liquid crystal panel to a backlight unit with a fixing tape having a frame shape in a liquid crystal panel mounting process.

Patent Document 1 further discloses bonding a protective member to the backlight unit for protecting a light exiting surface of the backlight unit to restrict adhesion of foreign substances to the light exiting surface prior to the process of mounting the liquid crystal panel to the backlight unit.

### RELATED ART DOCUMENT

### Patent Document

Patent Document 1: Unexamined Japanese Patent Application Publication No. 2009-3245

### Problem to be Solved by the Invention

In preparation of a fixing member having a frame shape such as the fixing tape (a fixing member) disclosed in Patent Document 1 is used, a middle portion inside the frame becomes a waste. Improvement in reduction of waste is expected. Furthermore, it is difficult to place the fixing member having the frame shape relative to the backlight unit with high accuracy. Improvement in that respect is also expected.

In recent years, a manpower reduction and automation are accelerating in a production process of liquid crystal display devices. There is the following problem for automation of the liquid crystal panel mounting process.

It is preferable that the protective member is tightly bonded to the backlight unit to achieve a sufficient level of protection for the light exiting surface of the backlight unit. However, complicated steps are required to remove the tightly bonded protective member from the backlight unit. Namely, manpower is required to perform such steps. Steps of removing the protective member are obstacles to the automation of the process of mounting the liquid crystal panel to the backlight unit. This is the problem.

### DISCLOSURE OF THE PRESENT INVENTION

The present invention was made in view of the above circumstances. An object is to protect a backlight unit and to automatize a production process of a liquid crystal display device.

### Means for Solving the Problem

A method of producing a display device according to the present invention includes a fixing member placing process, a protective member bonding process, and a panel mounting process. The fixing member placing process is for placing fixing members on a backlight unit. The fixing member placing process includes: placing the fixing members having an elongated shape and including first fixing surfaces and second fixing surfaces with longitudinal direction of the fixing members along peripheral edges of a light exiting surface of the backlight unit and a gap between ends of the fixing members; and bonding the first fixing surfaces of the fixing members to the peripheral edges of the light exiting surface. The protective member bonding process is for bonding a protective member for protecting the light exiting surface to the backlight unit after the fixing member placing process. The protective member bonding process includes bonding the protective member to the second fixing surfaces of the fixing members such that a peripheral edge of the protective member in a form of a canopy extends outward from the peripheral edge of the light exiting surface at least at a position corresponding to the gap between the fixing members. The panel mounting process is for mounting a display panel configured to display an image using light from the backlight unit to the backlight unit. The panel mounting process includes: removing the protective member bonded to the backlight unit to uncover the second fixing surfaces of the fixing members; and bonding the display panel to the second fixing surfaces to bond the display panel to the backlight unit with the fixing members.

In the method of producing a display device according to the present invention, the fixing members having the longitudinal shape are used. In comparison to a configuration in which a fixing member having a frame shape along peripheral edges of a light exiting surface, waste from the production of the fixing members can be reduced. Furthermore, the fixing members are placed relative to the backlight unit with high accuracy. The peripheral edge of the protective member in the form of a canopy extends outward from the peripheral edge of the light exiting surface at the position corresponding to the gap between the ends of the fixing members. In comparison to a configuration in which a protective member has the same shape as the light exiting surface, foreign substances including dust are less likely to enter inner than the light exiting surface through the gap between the fixing members.

In the panel mounting process, a force is applied to a projecting section of the peripheral edge of the protective member and thus the protective member can be easily removed. If the protective member is formed in a shape to surround the backlight unit to restrict the foreign substances from entering through the gap between the fixing members, the panel mounting process is difficult to be automatized because the removal of the protective member is complicated. According to the method of producing a display device according to the present invention, the panel mounting process can be properly automatized.

Preferable embodiments of the method of producing a display device according to the present invention may have the following configuration.

(1) The protective member may include a projecting portion that projects outward from a section of the peripheral edge. According to the configuration, a force can be applied to the projecting portion to remove the protective member in the panel mounting process. Therefore, the panel mounting process can be further properly automatized.

(2) The light exiting surface of the backlight unit may have a polygonal shape. The fixing member placing process may include placing the fixing members on sides of the light exiting surface, respectively. In the configuration in which the fixing members are placed on the sides of the light exiting surface having the polygonal shape, respectively, workability in the fixing member placing process is high but gaps are more likely to be provided at corners in which the fixing members are not placed. Because the protective member bonding process is as described above, the foreign substances including dust are less likely to enter inner than the light exiting surface through the gaps.

(3) The method may further include a protective tray setting process for setting the backlight unit in a protective tray for protecting the light exiting surface after the fixing member placing process. The protective tray may include sidewall surfaces opposed to end surfaces of peripheral edges of the backlight unit. The protective tray setting process may include: providing a storage space defined by the sidewall surfaces and the protective member for holding the backlight unit; and setting the backlight unit in the protecting tray. According to the configuration, entrance of the foreign substances from sides of the backlight unit, which is difficult to restrict by the protective member, can be restricted by the protective tray. Therefore, the entrance of the foreign substances including dust inner than the light exiting surface can be further properly restricted.

(4) The protective tray setting process may include setting multiple backlight units in the protective tray to collectively store the backlight units in the protective tray such that the protective members bonded to the backlight units are separated from one another. According to the configuration, multiple backlight units stored in the protective tray can be collectively handled (stored, transferred). Therefore, efficiency in production of the display device can be improved.

(5) The protective tray may include a bottom portion and thick portions. Multiple backlight units may be placed on the bottom portion. The thick portions may have a thickness greater than a thickness of the bottom portion. The thick portions may be arranged between the backlight units and include the sidewall surfaces. According to the configuration, rigidity of the protective tray improves and thus the backlight units can be collectively handled.

(6) The protective tray may include bosses that protrude to an opposite side from the backlight unit to which the protective member is bonded and stored in the protective tray relative to the protective member. The protective tray setting process may include: setting the backlight units in multiple protective trays; and placing the protective trays on top of one another such that the boss of one of the protective trays is opposed to another one of the protective trays. According to the configuration, the backlight units in the protective trays are less likely to contact the backlight units in other protective trays because of the bosses. Therefore, the backlight units can be further properly collectively handled.

A backlight unit package according to the present invention includes a backlight unit, fixing members, and a protective member. The backlight unit includes a light exiting surface. The fixing members are for bonding a display panel to the backlight unit. The fixing members having an elongated shape include first fixing surfaces and second fixing surfaces. The fixing members are disposed with longitudinal directions along peripheral edges of the light exiting surface of the backlight unit and with a gap between ends of the fixing members. The first fixing surfaces are bonded to the peripheral edges of the light exiting surface. The protective member is for protecting the light exiting surface of the backlight unit. The protective member is bonded to the second fixing surfaces of the fixing members such that a peripheral edge of the protective a peripheral edge of the protective member in a form of a canopy extends outward from the peripheral edge of the light exiting surface at least at a position corresponding to the gap between the fixing members.

In the backlight unit package according to the present invention, the fixing members having the elongated shape are used. In comparison to a configuration in which a fixing member having a frame shape along peripheral edges of a light exiting surface, waste from the production of the fixing members can be reduced. Furthermore, the fixing members are placed relative to the backlight unit with high accuracy. The peripheral edge of the protective member in the form of a canopy extends outward from the peripheral edge of the light exiting surface at the position corresponding to the gap between the ends of the fixing members. In comparison to a configuration in which a protective member has the same shape as the light exiting surface, foreign substances including dust are less likely to enter inner than the light exiting surface through the gap between the fixing members.

In the panel mounting process, a force is applied to a projecting section of the peripheral edge of the protective member and thus the protective member can be easily removed. If the protective member is formed in a shape to surround the backlight unit to restrict the foreign substances from entering through the gap between the fixing members, the panel mounting process is difficult to be automatized because the removal of the protective member is complicated. According to the method of producing a display device according to the present invention, the panel mounting process can be properly automatized.

### Advantageous Effect of the Invention

According to the present invention, a backlight unit can be protected and a production process of a liquid crystal display device can be automatized.

### BRIEF DESCRIPTION OF THE DRAWINGS

FIG. 1 is a cross-sectional view of a liquid crystal display device according to a first embodiment of the present invention.

FIG. 2 is a perspective view of a liquid crystal module included in the liquid crystal display device in FIG. 1.

FIG. 3 is an exploded perspective view of a backlight unit package.

FIG. 4 is an explanatory view schematically illustrating a fixing member placing process.

FIG. 5 is an explanatory view schematically illustrating a protective member bonding process.

FIG. 6 is an explanatory view schematically illustrating a protective tray setting process.

FIG. 7 is a cross-sectional view illustrating a backlight unit package stored in the protective tray (along line VII-VII).

FIG. 8 is an explanatory view schematically illustrating a protective member removing step in a panel mounting process.

FIG. 9 is a plan view illustrating a backlight unit package according to a second embodiment.

FIG. 10 is a cross-sectional view illustrating a backlight unit package stored in a protective tray according to a third embodiment.

FIG. 11 is a cross-sectional view illustrating a backlight unit package stored in a protective tray according to a fourth embodiment.

### MODE FOR CARRYING OUT THE INVENTION

### First Embodiments

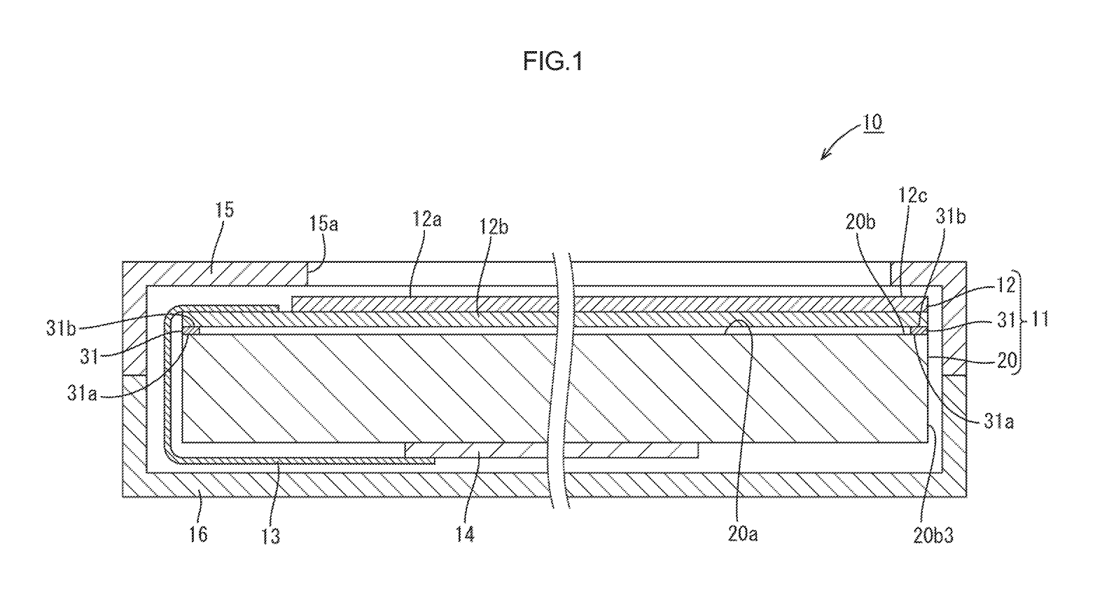

The first embodiment of the present invention will be described with reference to FIGS. 1 to 8. In this section, a method of producing a liquid crystal display device 10, and a backlight unit package 30 will be described.

As illustrated in FIG. 1, the liquid crystal display device 10 includes a liquid crystal module 11 as a major component. The liquid crystal display device 10 includes a front external member 15 and a rear external member 16 for holding the liquid crystal module 11. The front external member 15 includes a hole 15a through which images displayed on a liquid crystal panel 12 are viewed from the outside. Applications of the liquid crystal display device 10; for example, the liquid crystal display device 10 may be used for various kinds of electronic devices (not illustrated) such mobile phones (including smartphones), laptop personal computers (including tablet personal computers), mobile information terminals (including electronic books and PDAs), digital photo frames, portable video game players, car navigation systems, and instrument panels. The size of the liquid crystal panel 1 is not limited. The size may be in a range from some inches to 10and some inches.

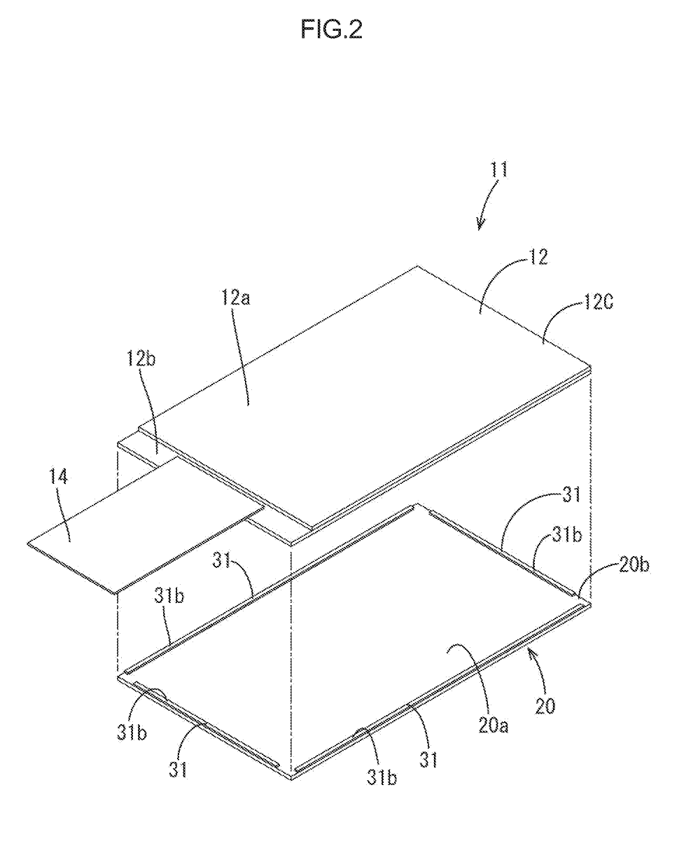

As illustrated in FIG. 2, the liquid crystal module 11 has a substantially rectangular shape in a plan view. The liquid crystal module 11 includes the liquid crystal panel 12 having a rectangular shape in a plan view and a backlight unit 20 (a lighting device) having a rectangular shape in a plan view. In the liquid crystal module 11, the liquid crystal panel 12 is bonded to the backlight unit 20 with fixing tapes 31 (fixing members).

The liquid crystal panel 12 is for displaying images using light from the backlight unit 20. As illustrated in FIGS. 1 and 2, the liquid crystal panel 12 includes a pair of transparent glass substrates 12a and 12b (having light transmissivity) and a liquid crystal layer between the substrates 12a and 12b. The liquid crystal layer includes liquid crystal molecules that are substances having optical characteristics that changes according to application of electric field. The substrates 12a and 12b are held with a gap corresponding to the thickness of the liquid crystal layer between the substrates 12a and 12b and bonded together with a sealing member. The substrates 12a and 12b are a color filter substrate 12a and an array substrate 12b, respectively. In this embodiment, the array substrate 12b is larger than the color filter substrate 12a. An edge of the array substrate 12b projects outward from the color filter substrate 12a. On a portion of the array substrate 12b, terminals (not illustrated) are formed. A flexible circuit board and a control circuit board 14 for supplying various signals for display images are mounted. Polarizing plates (not illustrated) are bonded to outer surfaces of the substrates 12a and 12b.

As illustrated in FIG. 1 and 2, fixing tapes 31 have an elongated shape and include first fixing surfaces 31a and second fixing surfaces 31b. The fixing tapes 31 have light blocking properties (for instance, the fixing tapes 31 are in black) to restrict light rays from the backlight unit 20 from unexpectedly entering the liquid crystal panel 12 (especially through peripheral end surfaces). The first fixing surfaces 31a of the fixing tapes 31 are fixed to the peripheral edges 20b of the backlight unit 20 and the second fixing surfaces 31b are fixed to peripheral edges 12c of the liquid crystal panel 12.

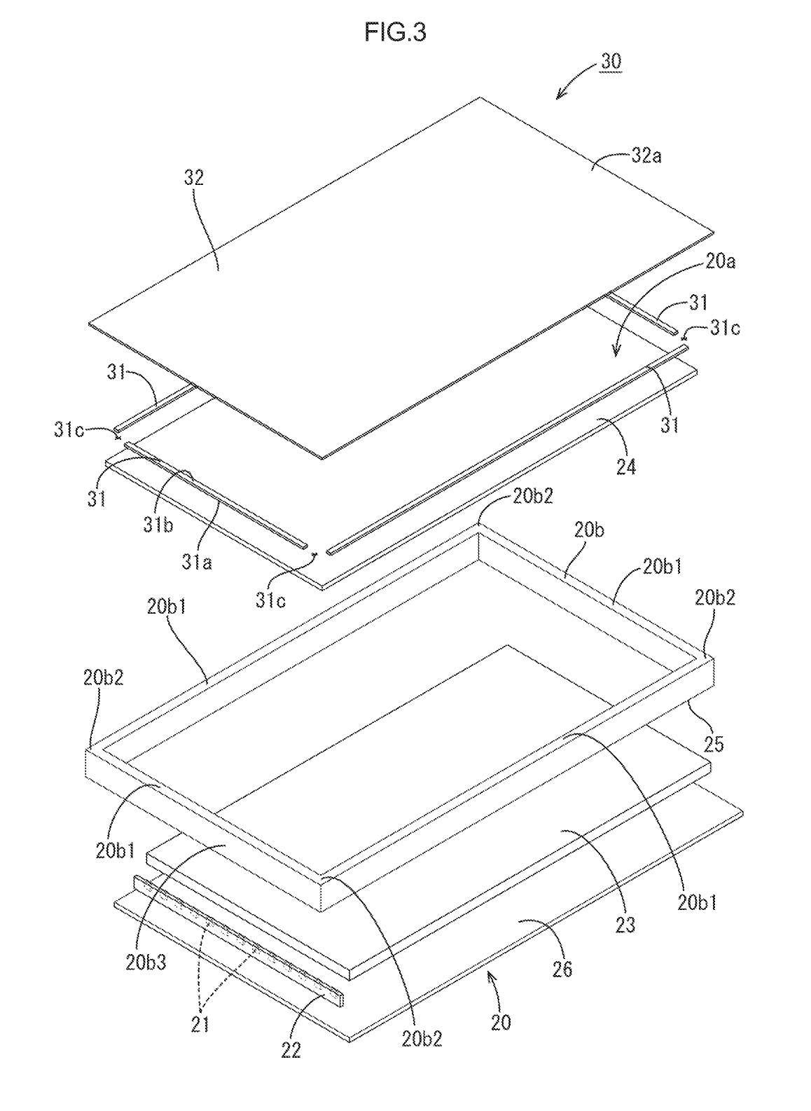

As illustrated in FIG. 1, the backlight unit 20 has a panel-like overall shape (a block-like overall shape) similar to that of the liquid crystal panel 12. As illustrated in FIG. 3, the backlight unit 20 includes light emitting diodes (LEDs) 21 that are light sources, an LED board 22 (a light source board) on which the LEDs 21 are mounted, a light guide plate 23, optical sheets 24 (an optical member), a frame 25, and a chassis 26. The light guide plate 23 guides light rays from the LEDs 21. The optical sheets 24 are disposed in layers on the light guide plate 23, The frame 25 and the chassis 26 are coupled to accommodate the LED board 22, the light guide plate 23, the optical sheets 24, and the liquid crystal panel 12. The backlight unit 20 is a so-called edge light type (or side light type) backlight in which the LEDs 21 (or the LED board 22) are disposed on one of ends of the long dimension of the backlight unit 20. The surface of the backlight unit 20 bonded to the liquid crystal panel 12 is a light exiting surface 20a.

As illustrated in FIG. 3, each LED 21 is enclosed with a resin on a base fixed to the LED board 22. The LED board 22 extends in a short direction of the light guide plate 23 and the chassis 26. The LED board 22 is set in a position such that a plate surface of the LED board 22 is perpendicular to plate surfaces of the liquid crystal panel 12 and the light guide plate 23.

As illustrated in FIG. 3, the light guide plate 23 is made of substantially transparent synthetic resin (having high light transmissivity) having an light refractive index sufficiently higher than that of the air (e.g., acrylic). The light guide plate 23 has a horizontally rectangular flat plate shape in a plan view similar to the liquid crystal panel 12. The plate surfaces of the light guide plate 23 are parallel to the plate surfaces of the liquid crystal panel 12. The light guide plate 23 is disposed immediately behind the liquid crystal panel 12 and the optical sheets 24. One of the peripheral end surfaces at an end of the long dimension is opposed to the LEDs 21 on the LED board 22. The light guide plate 23 has a function for receiving light rays emitted by the LEDs 21 through the end surface at an end of the long dimension, passing the light rays therethrough, and direct the light rays toward the optical sheets (on the front side, the light exiting side) such that the light rays exit through the plate surface.

As illustrated in FIG. 3, the optical sheets 24 have a horizontally-long rectangular shape in a plan view similar to those of the liquid crystal panel 12 and the chassis 26. The optical sheets 24 are disposed between the liquid crystal panel 12 and the light guide plate 23. The optical sheets 24 pass the light rays from the light guide plate 23, exert predefined optical effects on the passing light rays, and direct the light rays toward the liquid crystal panel 12. The optical sheets 24 (three of them in this embodiment) are disposed on top of one another. The optical sheet 24 forms the light exiting surface 20a of the backlight unit 20.

The frame 25 is made of synthetic resin. As illustrated in FIG. 3, the frame 25 is formed in a substantially frame shape (picture frame shape) along the peripheral end surfaces of the light guide plate 23. The frame 25 has a function for holding the LED board 22, the light guide plate 23, and the optical sheets 24 within a framework thereof. The frame 25 extends along the peripheral edges 12c of the liquid crystal panel 12 and includes panel supporting surfaces 20b for supporting the liquid crystal panel 12. The panel supporting surfaces 20b are peripheral edges 20b of the light exiting surface 20a outside the optical sheets 24. In the following description, the panel supporting surfaces 20b may be referred to as the peripheral edges 20b. The first fixing surfaces 31a of the fixating tapes 31 are fixed to the panel supporting surfaces 20b and the liquid crystal panel 12 is fixed to the panel supporting surfaces 20b with the fixing tapes 31. A portion of the frame 25 on an opposite side from the panel supporting surfaces 20b is fixed to the chassis 26 with an adhesive layer and a fixing portion, which are not illustrated. The frame 25 forms a case of the backlight unit 20, that is, an exterior of the backlight unit 20, together with the chassis 26. The frame 25 adds the rigidity to the backlight unit 20 and restricts entrance of foreign substances into the backlight unit 20.

The chassis 26 is formed from a metal sheet having high thermal conductivity such as an aluminum sheet and an electrogalvanized steel sheet (SEC). As illustrated in FIG. 3, the chassis 26 has a horizontally-long rectangular shape similar to the liquid crystal panel 12. The chassis 26 supports the light guide plate 23 from the rear side (an opposite side from the light exiting surface side). In a space behind the chassis 26, circuit boards including the control circuit board 14 and an LED driver board for supplying drive power to the LEDs 21 (see FIG, 1) and a battery (not illustrated) are disposed.

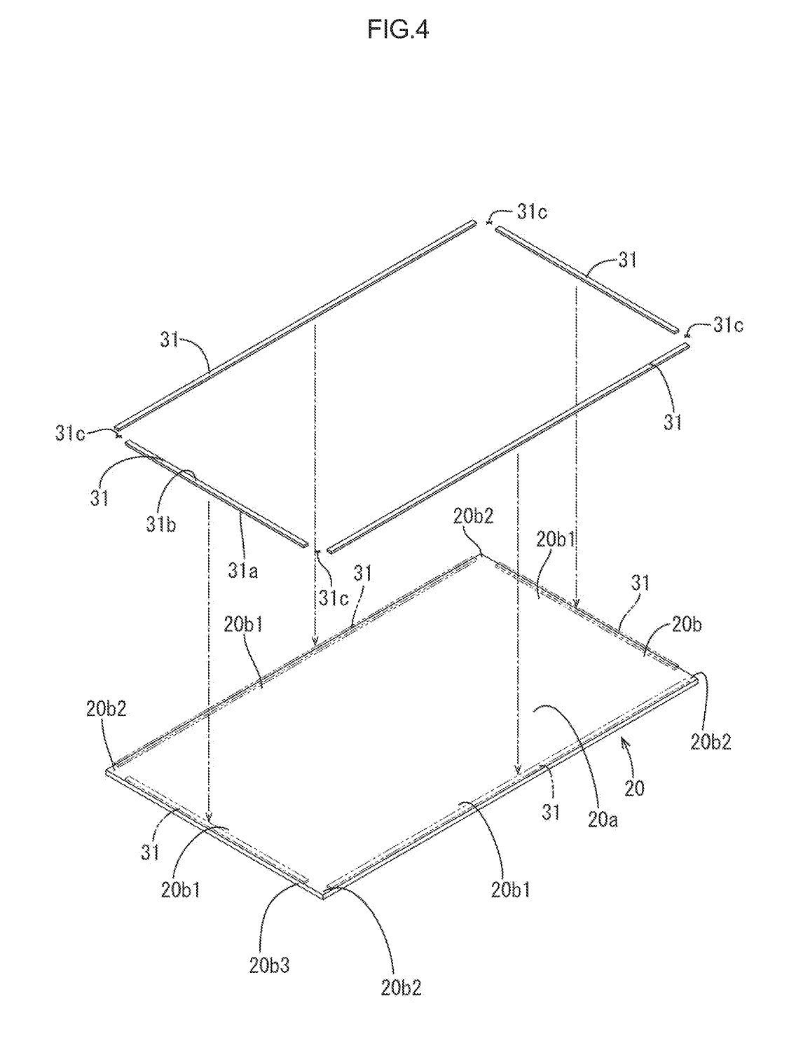

Next, the method of producing the liquid crystal display device 10 (the liquid crystal module 11) will be described with reference to FIGS. 4 to 8. The method of producing the liquid crystal display device 10 (the liquid crystal module 11) includes a fixing member placing process, a protective member bonding process, a protective tray setting process, and a panel mounting process. In the fixing member placing process, the fixing tapes 31 are placed on the backlight unit 20. In the protective member bonding process performed after the fixing member placing process, a protective member 32 for protecting the light exiting surface 20a of the backlight unit 20 is bonded to the backlight unit 20. In the protective tray setting process performed after the fixing member placing process, the backlight unit 20 is stored in the protective tray 40 for protecting the light exiting surface 20a of the backlight unit 20. In the panel mounting process, the liquid crystal panel 12 is mounted to the backlight unit 20. Through this method, a backlight unit package 30, which is an interim product between the protective member bonding process and the panel mounting process, is prepared. First, the configuration of the backlight unit package 30 will be described and then the processes including the fixing member placing process, the protective member bonding process, the protective tray setting process, and the panel mounting process will be described in sequence.

As illustrated in FIG. 3, the backlight unit package 30 includes the backlight unit 20, the fixing tapes 31, and the protective member 32 that is for protecting the light exiting surface 20a of the backlight unit 20. Namely, the backlight unit package 30 has a configuration in which the backlight unit 20 and the fixing tapes 31 of the liquid crystal display device 10 are covered with the protective member 32. Releasable treatment may be performed on the protective member 32 or the protective member 32 may be indirectly bonded to the second fixing surfaces 31b of the fixing tapes 31 via other adhesive layers having smaller adhesive forces. Namely, the protective member 32 is bonded to the backlight unit 20 such that the protective member 32 is removable from the other fixing surfaces 31b.

As illustrated in FIG. 3, the protective member 32

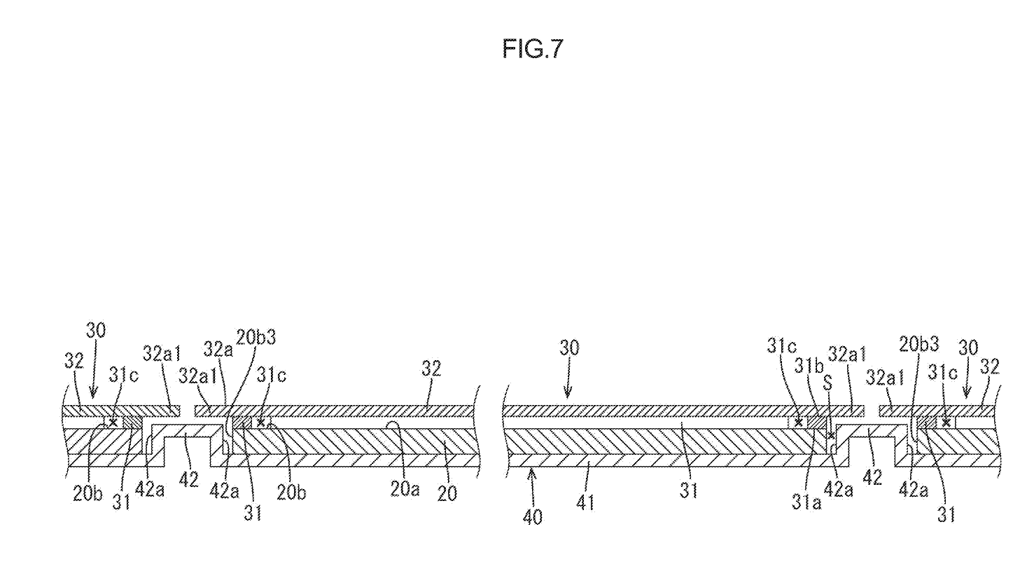

has a rectangular plate shape (a panel-like shape) slightly larger than the outer shape of the backlight unit 20. The protective member 32 is made of polyethylene terephthalate. In comparison to a protective sheet having high flexibility to wrap a backlight unit in the protective sheet (e.g., a protective sheet made of nylon of polyethylene), the protective member 32 is stiffer (tougher). The stiffness of the protective member 32 may be set such that a projecting section of the peripheral edge of the protective member 32 bonded to an upper portion of the backlight unit with respect to the vertical direction with the fixing tape 31 does not droop to the lower side of the backlight unit 20 (see FIG. 7). In this embodiment, the protective member 32 is formed in the substantially panel shape with higher stiffness in comparison to a conventional protective member. Therefore, the protective member 32 is easier to handle and thus bonding and removal of the protective member 32 can be more easily automatized.

As illustrated in FIG. 4, in the fixing member placing process, the fixing tapes 31 are placed with longitudinal directions thereof along the peripheral edges 20b of the light exiting surface 20a of the backlight unit 20 and with gaps 31c between adjacent ends of the fixing tapes 31. Then, the first fixing surfaces 31a of the fixing tapes 31 are bonded to the corresponding peripheral edges 20b of the light exiting surface 20a. In the fixing member placing process of this embodiment, the fixing tapes 31 are placed to sides 20b1 of the light exiting surface 20a of the backlight unit 20, respectively. The fixing tapes 31 that are placed as described above linearly extend along the respective sides 20b1. Furthermore, gaps 31c are formed between the ends of the adjacent fixing tapes 31. According to the configuration, in the fixing member placing process, the ends of the fixing tapes 31 are less likely to overlap each other due to dimensional errors or assembly errors. If the fixing members overlap each other, a thickness of the overlapping portion is larger than a thickness of other portions. Therefore, the evenness of the fixing members may not be maintained and thus the evenness of the liquid crystal module may not be maintained. In this embodiment, such a problem is less likely to occur.

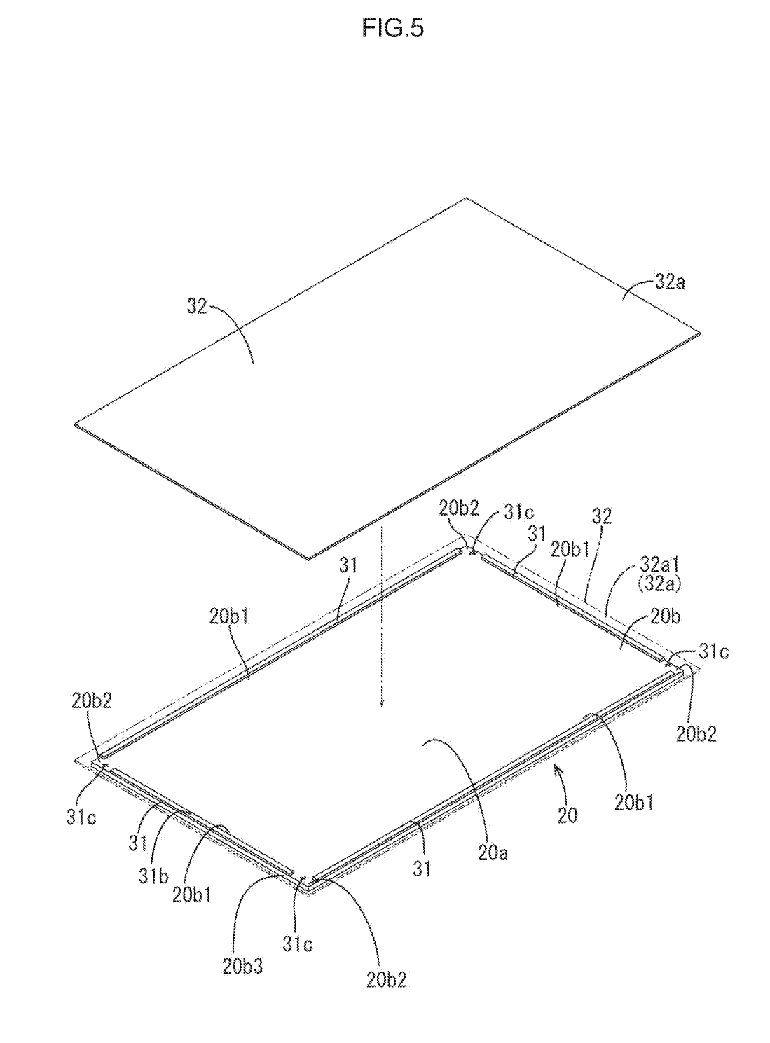

As illustrated in FIG. 5, in the protective member bonding process, the protective member 32 is bonded to the second fixing surfaces 31b of the fixing tapes 31 such that the peripheral edges 32a of the protective member 32 in a form of a canopy extend outward from sections of the peripheral edges 20b of the light exiting surface 20a at least at positions corresponding to the gaps 31c between the fixing tapes 31. In this embodiment, the peripheral edges 32a of the protective member 32 in the form of a canopy extend from the peripheral edges 20b of the light exiting surface 20a for the entire periphery. According to the configuration, in comparison to a configuration in which the peripheral edges 32a of the protective member 32 in the form of a canopy extend from only sections of the peripheral edges 20b, the light exiting surface 20a is more properly protected. The protective member 32 bonded to the backlight unit 20 projects outward from the peripheral edge 20b of the backlight unit 20 in a range from 1 mm to 10 mm (see FIG. 7). The portions of the protective member 32 projecting outward may be referred to as projecting portions 32a1. With dimensions of the projecting portions 32a1 in projecting directions equal to or greater than 1 mm, a sufficient level of effects of restricting entrance of foreign substances can be achieved. With the dimension of the projecting portions 32a1 in the projecting directions equal to or smaller than 10 mm, the protective member 32 can retain its shape. Therefore, handling of the backlight unit package 30, especially in an automated process becomes easier.

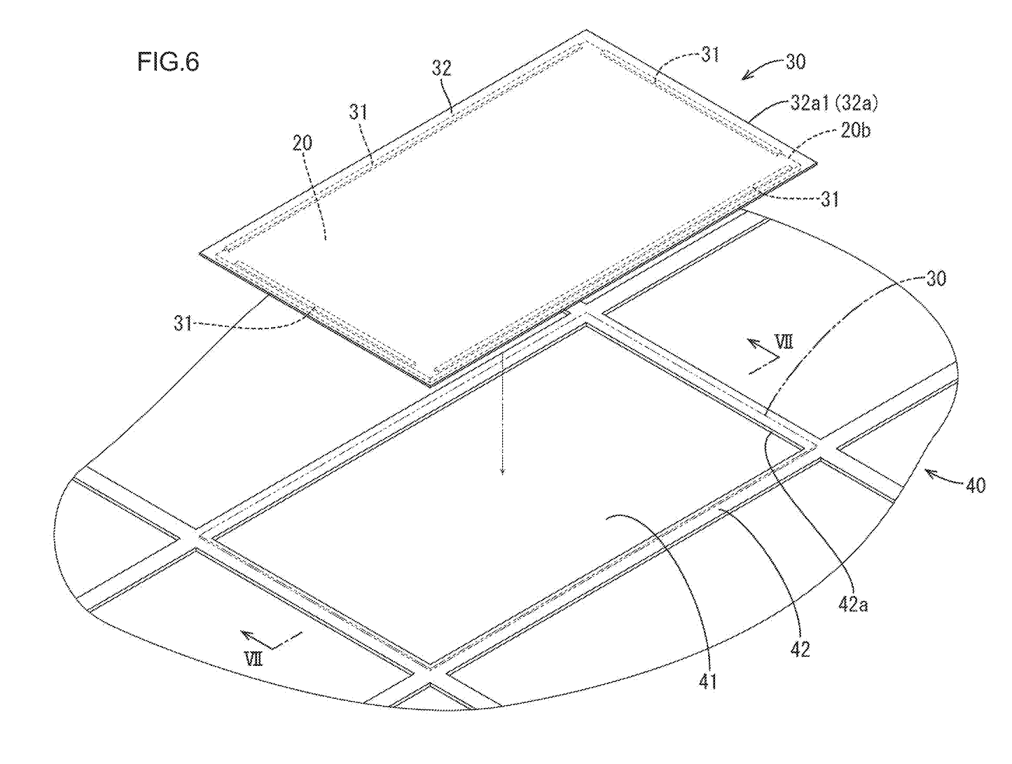

As illustrated in FIGS. 6 and 7, in the protective tray setting process, storage spaces S defined by sidewall surfaces 42a of the protective tray 40 and protective members 32 are provided for storing backlight units 20. The sidewall surfaces 42a are opposed to end surfaces 20b3 of the peripheral edges 20b of the backlight units 20. The backlight units 20 are stored in the storage spaces S. In this embodiment, the backlight units 20 are collectively stored in the protective tray 40 such that the protective members 32 bonded to the respective backlight units 20 are separated from one another. In this embodiment, the protective tray setting process is performed after the protective member bonding process and backlight unit packages 30 are stored. However, the protective tray setting process may be performed before the protective member bonding process. Then, the protective members 32 may be bonded to the backlight units 20 after the backlight units 20 are stored. The protective tray 40 used in the protective tray setting process may have the following configuration.

The protective tray 40 has a shallow box overall shape (a shallow tray shape). As illustrated in FIGS. 6 and 7, the protective tray 40 includes a bottom portion 41 that is divided into grid sections so that multiple backlight units 20 are placed on the bottom portion 41. Specifically, the bottom portion 41 of the protective tray 40 having a plate shape is divided into the sections with bent portions 42 that are formed into a U shape by bending portions of the bottom portion 41 in a direction that crosses the plate surface of the bottom portion 41. The sections of the protective tray 40 hold the backlight units 20, respectively. In this embodiment, the bent portions 42 of the protective tray 40 include sidewall surfaces 42a that are opposed to end surfaces 20b3 of the peripheral edges 20b of the backlight units 20. The sidewall surfaces 42a extend in directions perpendicular to the bottom portion 41. The top surfaces of the bent portions 42 (on an opposite side from the bottom portion 41 side) are opposed to the protective members 32 with gaps therebetween. Furthermore, the protective members 32 of the backlight unit packages 30 that are set adjacent to each other are arranged to be separated from each other above the bent portions 42. The gaps between the protective members 32 are sufficiently large so that the adjacent protective members 32 do not touch each other with consideration of clearance (play) in each section in which the corresponding backlight unit 20 is set. Namely, the protective tray 40 is configured such that the side wall surfaces 42a touch the frame 25 (the end surfaces 20b3) arid the bottom portion 41 touches the chassis 26 but the other portions do not touch the backlight unit packages 30 (non-contact configuration). Furthermore, multiple protective trays 40 can be disposed on top of each other without touching the backlight unit packages 30 set inside the protective trays 40. Namely, each protective tray 40 has the configuration for storing and transferring the backlight units 20 collectively protected by the protective tray 40.

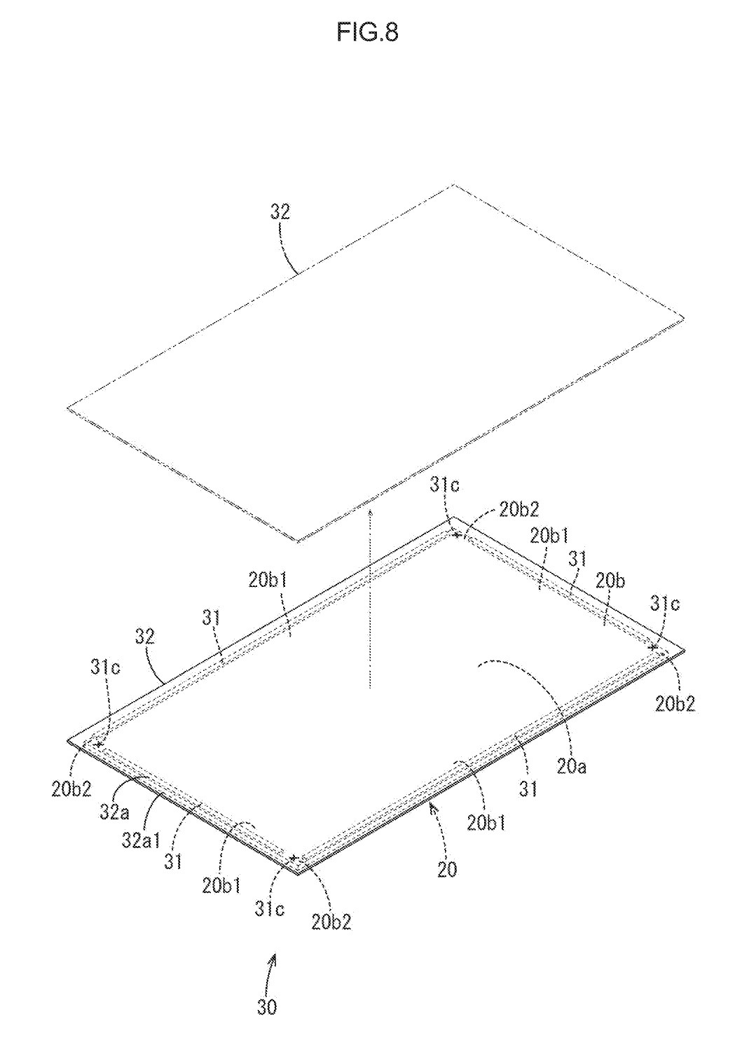

The panel mounting process includes the protective member removing process and the panel bonding process. In the protective member removing process, the protective members 32 bonded to the backlight units 20 are removed to uncover the second fixing surfaces 31b of the fixing tapes 31. In the panel bonding process, the liquid crystal panel 12 is bonded to the second fixing surfaces 31b and to the backlight units 20 with the fixing tapes 31 after the protective member removing process. Specifically, in the protective member removing process, as illustrated in FIG. 8, a force is applied to a section of the projecting portion 32a1 in an opposite direction from the backlight unit 20 to remove the protective member 32 from each backlight unit 20. Because the projecting portion 32a1 is in a form of a canopy and a way of hold the projecting portion 32a1, the force for removing the protective member 32 can be easily applied to the plate surface of the projecting portion 32a1. Furthermore, the removing direction is one direction. Namely, the protective member removing process can be easily automatized. In the panel bonding process, the liquid crystal panel 12 is brought closer to the backlight unit 20 from the uncovered fixing tape 31 side and bonded to the backlight unit 20 (see FIG. 2).

Next, the method of producing the liquid crystal display device 10 according to this embodiment and functions, operations, and effects of the backlight unit packages 30 will be described.

The method of producing the liquid crystal display device 10 according to this embodiment includes the fixing member placing process, the protective member bonding process, and the panel mounting process. The fixing member placing process is for placing the fixing tapes 31 on the backlight unit 20. In the fixing member placing process, the elongated fixing tapes 31 including the first fixing surfaces 31a and the second fixing surfaces 31b are placed with the longitudinal directions along the peripheral edges 20b of the light exiting surface 20a of the backlight unit 20 and with the gaps 31c between the adjacent ends. Then, the first fixing surfaces 31a of the fixing tapes 31 are bonded to the peripheral edges 20b of the light exiting surface 20a. The protective member bonding process is performed after the fixing member placing process for bonding the protective members 32 for protecting light exiting surfaces 20a to the backlight units 20. In the protective member bonding process, the protective member 32 is bonded to the second fixing surfaces 31b of the fixing tapes 31 such that the peripheral edges 32a of the protective member 32 project outward from the peripheral edges 20b of the light exiting surface 20a at least at the positions corresponding to the gaps 31c between the fixing tapes 31. The panel mounting process is for mounting the liquid crystal panel 12 that is configured to display images using light from the backlight unit 20 to the backlight unit 20. In the panel mounting process, the protective member 32 bonded to the backlight unit 20 is removed so that the second fixing surfaces 31b of the fixing tapes 31 are uncovered and the liquid crystal panel 12 is bonded to the second fixing surfaces 31b to bond the liquid crystal panel 12 to the backlight unit 20 with the fixing tapes 31.

According to the method of producing the liquid crystal display device 10 according to this embodiment in which the longitudinal fixing tapes 31 are used, in comparison to a configuration in which the fixing tape 31 having a frame shape along the peripheral edges 20b of the light exiting surface 20a, waste from the production of the fixing tapes 31 can be reduced. Furthermore, the fixing tapes 31 are placed relative to the backlight units 20 with high accuracy. The peripheral edges 32a of each protective member 32 in the form of a canopy extend outward from the peripheral edges 20b of the light exiting surface 20a at the positions corresponding to the gaps 31c between the ends of the adjacent fixing tapes 31. In comparison to a configuration in which each protective member 32 has the same shape as the light exiting surface 20a, foreign substances including dust are less likely to enter inner than the light exiting surface 20a through the gaps 31c between the fixing tapes 31. For bonding the liquid crystal panel 12 to the backlight unit 20 to mount the liquid crystal panel 12 to the backlight unit 20, the backlight unit 20 may be stored and transferred as it is. According to this embodiment, the entrance of the foreign substances including dust inner than the light exiting surfaces 20a of the backlight units 20 through the gaps 31c between the fixing tapes 31 due to vibrations during handling of the backlight units 20 can be restricted by the projecting portions 32a1 of the protective members 32.

According to the method of producing the liquid crystal display device 10 according to this embodiment, the force is applied to the projecting portion 32a1 of the peripheral edges 32a of the protective member 32 and thus the protective member 32 can be easily removed. If the protective member 32 is formed in a shape to surround the backlight units to restrict entrance of the foreign substances through the gaps between the fixing tapes 31, it may be difficult to automatize the panel mounting process because the removal of the protective member 32 is complicated. According to the method of producing the liquid crystal display device 10 according to this embodiment, the panel mounting process can be properly automatized.

In this embodiment, the light exiting surface 20a of the backlight unit 20 has a polygonal shape. In the fixing member placing process, the fixing tapes 31 are placed on the sides 20b1 of the light exiting surface 20a, respectively. In the configuration in which the fixing tapes 31 are placed on the sides 20b1 of the light exiting surface 20a having the polygonal shape, respectively, workability in the fixing member placing process is high but the gaps 31c are more likely to be provided at corners 20b2 in which the fixing tapes 31 are not placed. Because the protective member bonding process is as described above, the foreign substances including dust are less likely to enter inner than the light exiting surface 20a through the gaps 31c.

In this embodiment, the protective tray setting process is performed after the fixing member placing process. In the protective tray setting process, the backlight unit 20 is stored in the protective tray 40 for protecting the light exiting surface 20a. The protective tray 40 includes the sidewall surfaces 42a opposed to the end surfaces 20b3 of the peripheral edges 20b of the backlight unit 20. In the protective tray setting process, the storage space S defined by the sidewall surfaces 42a and the protective member 32 is provided for storing the backlight unit 20. Then, the backlight unit 20 is stored in the protective tray 40. According to the configuration, entrance of foreign substances from sides of the backlight unit 20, which are difficult to be restricted by the protective member 32, is restricted by the protective tray 40. Therefore, the entrance of the foreign substances including dust inner than the light exiting surfaces 20a is more properly restricted.

In this embodiment, in the protective tray setting process, multiple backlight units 20 are collectively stored in the protective tray 40 such that the protective members 32 that are bonded to backlight units 20 respectively are separated from one another. According to the configuration, the backlight units 20 stored in the protective tray 40 can be collectively handled (stored, transferred, and so on). Efficiency in production of the liquid crystal display device 10 improves.

The backlight unit package 30 in this embodiment includes the backlight unit 20, the fixing tapes 31, and the protective member 32. The backlight unit 20 includes the light exiting surface 20a. The fixing tapes 31 are for bonding the liquid crystal panel 12 to the backlight unit 20. The fixing tapes 31 nave the elongated shape and include the first fixing surfaces 31a and the second fixing surfaces 31b. The fixing tapes 31 are placed with the longitudinal directions along the peripheral edges 20b of the light exiting surfaces 20a of the backlight units 20 and with the gaps 31c between the ends of the adjacent fixing tapes 31. The first fixing surfaces 31a are bonded to the peripheral edges 20b of the light exiting surfaces 20a. The protective member 32 is for protecting the light exiting surface 20a of the backlight unit 20. The protective member 32 is bonded to the second fixing surfaces 31b of the fixing tapes 31 such that the peripheral edges 32a of the protective member 32 project outward from the peripheral edges 20b of the light exiting surface 20a at least at the positions corresponding to the gaps 31c between the fixing tapes 31.

In the backlight unit package 30 in this embodiment the longitudinal fixing tapes 31 are used. In comparison to the configuration in which the fixing tape 31 having the frame shape along the peripheral edges 20b of the light exiting surface 20a, the waste from the production of the fixing tapes 31 can be reduced. Furthermore, the fixing tapes 31 are placed on the backlight unit 20 with high accuracy. The peripheral edges 32a of the protective member 32 in the form of a canopy extend outward from the peripheral edges 20b of the light exiting surface 20a at the positions corresponding to the gaps 31c between the adjacent ends of the fixing tapes 31. In comparison to a configuration in which each protective member 32 has the same shape as the light exiting surface 20a, foreign substances including dust are less likely to enter inner than the light exiting surface 20a through the gaps 31c between the fixing tapes 31. For bonding the liquid crystal panel 12 to the backlight unit 20 to mount the liquid crystal panel 12 to the backlight unit 20, the backlight unit 20 may be stored and transferred as it is. According to this embodiment, the entrance of the foreign substances including dust inner than the light exiting surfaces 20a of the backlight units 20 through the gaps 31c between the fixing tapes 31 due to vibrations during handling of the backlight units 20 can be restricted by the projecting portions 32a1 of the protective member 32.

According to the backlight unit package 30 in this embodiment, in the panel mounting process, the force is applied to the projecting portion 32a1 of the peripheral edges 32a of the protective member 32 and thus the protective member 32 can be easily removed. If the protective member 32 is formed in a shape to surround the backlight unit to restrict entrance of the foreign substances through the gaps between the fixing tapes 31, it may be difficult to automatize the panel mounting process because the removal of the protective member 32 is complicated. According to this embodiment, the panel mounting process can be properly automatized.

### Second Embodiment

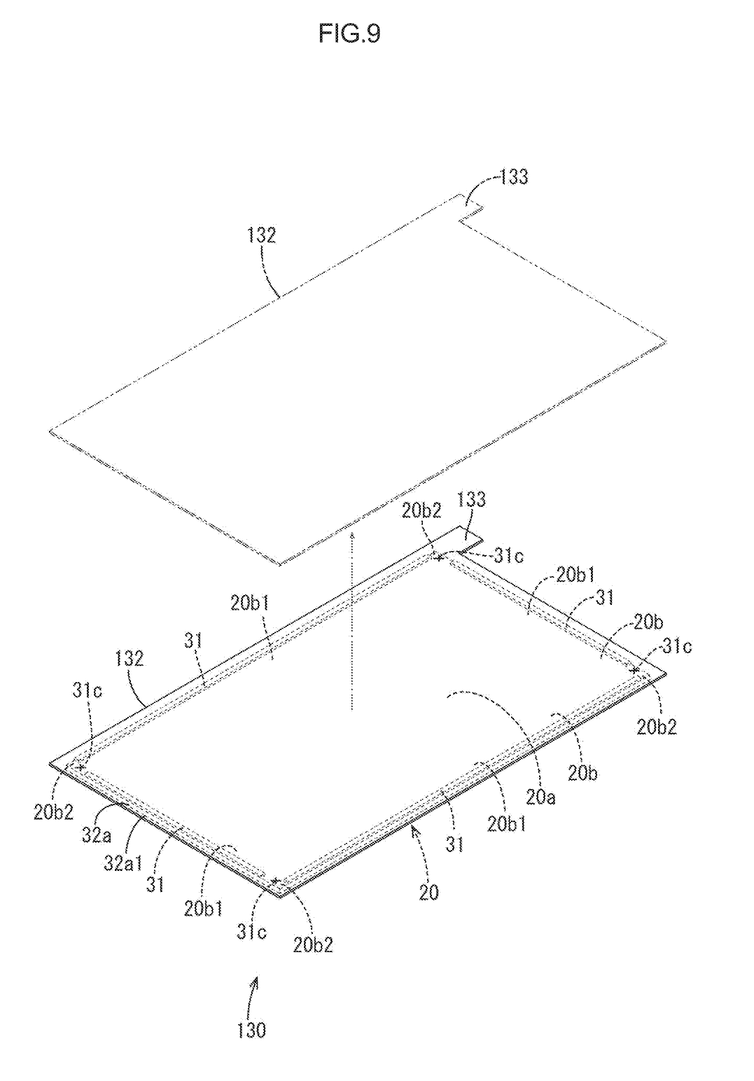

A second embodiment of the present invention will be described with reference to FIG. 9. In the second embodiment section, a backlight unit package 130 including a protective member 132 that includes a projecting portion 133 that projects from a peripheral edge 32a will be described. Configurations, functions, and effects similar to those of the first embodiment will not be described.

The protective member 132 includes the projecting portion 133 that projects outward from a section of the peripheral edge 32a. The projecting portion 133 has a rectangular shape and projects from a short edge of the protective member 132 at a position corresponding to a corner 20b2 of a backlight unit 20 in a direction perpendicular to the short direction of the protective member 132. To remove the protective member 32, it is preferable to slowly remove the fixing tapes 31 in the longitudinal directions of the fixing tapes 31. In this embodiment in which the projecting portion 133 is formed at the position corresponding to the corner 20b2 of the backlight unit 20, the fixing tapes 31 bonded to the backlight unit 20 along the short direction of the backlight unit 20 and along the long direction of the backlight unit 20 can be easily removed with a force applied to the projecting portion 133.

According to this embodiment, in the panel mounting process, the protective member 132 can be removed with the force applied to the projecting portion 133. Therefore, the panel mounting process can be further properly automatized.

### Third Embodiment

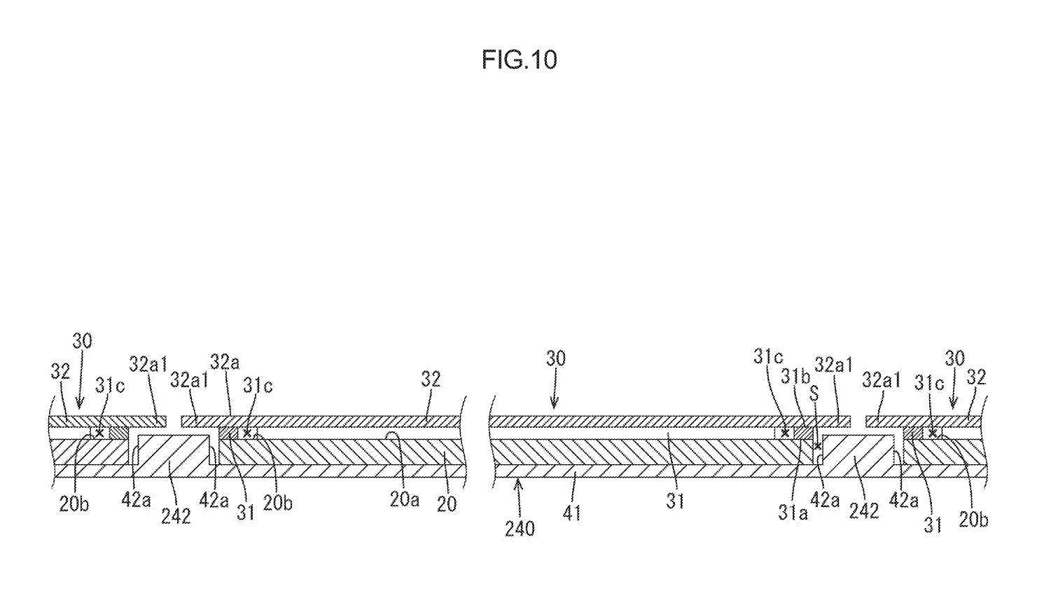

A third embodiment will be described with reference to FIG. 10. In the third embodiment section, a protective tray 240 including thick portions 242 instead of the bent portions 42 for defining sections. Configurations, functions, and effects similar to those of the first embodiment will not be described.

The protective tray 240 includes a bottom portion 41 and the thick portions 242. Multiple backlight units 20 can be placed on the bottom portion 41. The thick portions 242 have a thickness larger than that of the bottom portion 41. The thick portions 242 are arranged between the backlight units 20. The thick portions 242 include sidewall surfaces 42a. In this embodiment, portions of a protective tray 240 including the sidewall surfaces 42a (the thick portions 242) are in forms of ribs that protrude from the bottom portion 41.

According to this embodiment, rigidity of the protective tray 40 improves and multiple backlight units 20 can be properly handled at one time.

### Fourth Embodiment

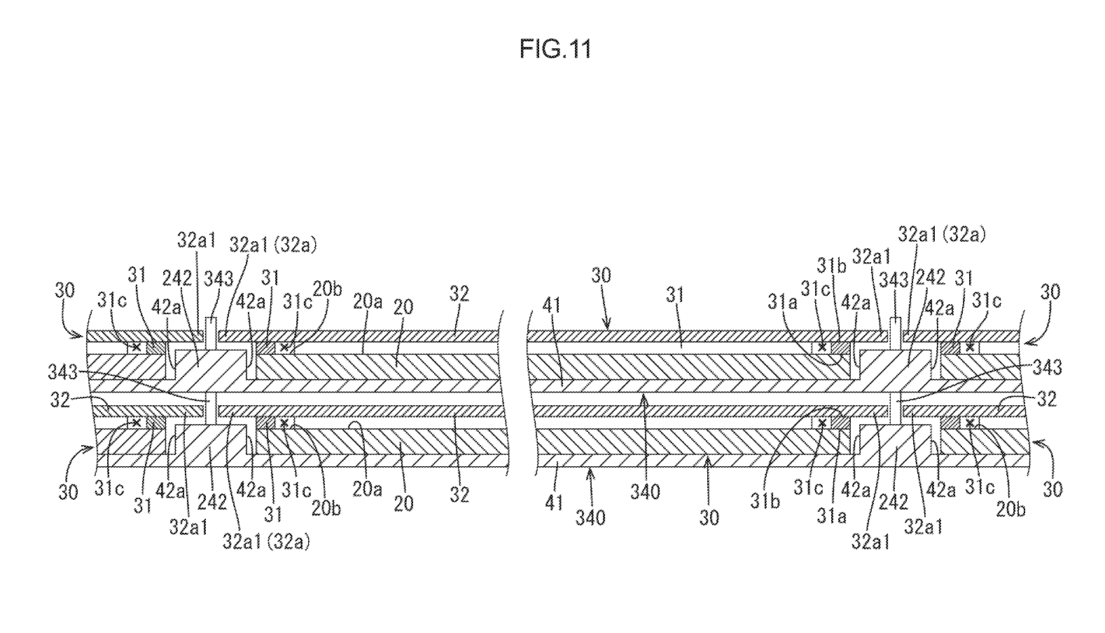

A fourth embodiment of the present invention will be described with reference to FIG. 11. In the fourth embodiment section, protective trays 340 including bosses 343 will be described. Configurations, functions, and effects similar to those of the third embodiment will not be described.

The protective trays 340 include the bosses 343 that protrude to an opposite side from backlight units 20 relative to protective members 32 that are bonded to the backlight units 20 that are stored in the protective trays 340. In a protective tray setting process, the backlight units 20 are stored in the protective trays 340 and the bosses 343 of one of the protective trays 340 are opposed to another protective tray 340 (the bottom portion 41). The rest of the protective trays 340 are disposed on top of one another in the same manner. The bosses 343 are disposed between the protective members 32 of the adjacent backlight unit packages 30 stored in the protective trays 340 to restrict contact between the protective members 32.

In this embodiment, the bosses 343 restrict contact between the backlight units 20 stored in the protective tray 340 and another protective tray 340. Therefore, multiple backlight units 20 are further properly handled at one time.

### Other Embodiments

The present invention is not limited to the embodiments described in the above sections and the drawings. For example, the following embodiments may be included in technical scopes of the technology.

(1) In each of the first embodiment, the protective members in the form of a canopy extend for the entire peripheral edges of the backlight unit. However, the configuration of the protective members is not limited to such a configuration. For example, protective members in the form of a canopy may be provided at positions corresponding to the gaps between the fixing members.

(2) In each of the above embodiments, one of the surfaces of each fixing member is bonded to the frame of each backlight unit. However, the one of the surfaces may be bonded to an appropriate component other than the frame.

(3) The shape, the number, and the arrangement of the fixing members may be altered from those of each of the above embodiment as appropriate. The gaps between the fixing members may be formed at positions corresponding to sections of the light exiting surfaces of the backlight units other than the corners. The gaps between the fixing members are not limited to the gaps between the ends of the adjacent fixing members. For example, a gap between a first end and a second end of each fixing member may be included in the scope of the present invention.

(4) In each of the above embodiments, the backlight units have the rectangular shape in the plan view. However, the shape of the backlight units is not limited to rectangular. For example, the backlight units may nave a polygonal shape such as a triangular shape, a pentagonal shape, and a hexagonal shape or a shape including curves such as a round shape and an oval shape.

(5) The configurations of the backlight units may be altered from those of the above embodiments as appropriate. In each of the above embodiments, the chassis has the planar shape. However, the chassis may have a box-like shape for holding the light source board and the light guide plate therein. The fixing members may be bonded to such a chassis.

(6) In each of the above embodiments, multiple backlight units are stored in the protective tray. However, a single backlight unit may be stored in the protective tray.

(7) In each of the above embodiments, the method of producing the liquid crystal display device includes the protective tray setting process. However, the present invention is applicable to a method of producing a liquid crystal display device without the protective tray setting process.

(8) The position, the shape, and the number of the projecting portions can be altered from those of the second embodiment as appropriate.

(9) The shape and the material of the protective members and/or the protective trays may be altered from those of the above embodiments.

(10) In each of the above embodiments, the LEDs are used as the light sources. However, other types of light sources may be used.

(11) In each of the above embodiments, the liquid crystal display device includes the edge light type backlight unit. However, a direct type backlight unit may be used.

(12) In each of the above embodiments, the liquid crystal display device includes the liquid crystal panel as a display panel. However, the present invention can be applied to display devices including other types of display panels.

### EXPLANATION OF SYMBOLS

10: Liquid crystal display device (Display device)
12: Liquid crystal panel (Display panel)
20: Backlight unit
20a: Light exiting surface
20b: Peripheral edge
20b3: End surface
30, 130: Backlight unit package
31: Fixing tape (Fixing member)
31a: First fixing surface
31b: Second fixing surface
31c: Gap
32, 132: Protective member
32a: Peripheral edge
40, 240, 340: Protective tray
41: Bottom portion
42a: Sidewall surface
133: Projecting portion
242: hick portion
343: Boss
S: Storage space

1. A method of producing a display device comprising:
a fixing member placing process for placing fixing members on a backlight unit, the fixing member placing process comprising:
placing the fixing members having an elongated shape and including first fixing surfaces and second fixing surfaces with longitudinal directions of the fixing members along peripheral edges of a light exiting surface of the backlight unit and a gap between ends of the fixing members; and
bonding the first fixing surfaces of the fixing members to the peripheral edges of the light exiting surface;
a protective member bonding process for bonding a protective member for protecting the light exiting surface to the backlight unit after the fixing member placing process, the protective member bonding process comprising bonding the protective member to the second fixing surfaces of the fixing members such that a peripheral edge of the protective member in a form of a canopy extends outward from the peripheral edge of the light exiting surface at least at a position corresponding to the gap between the fixing members; and
a panel mounting process for mounting a display panel configured to display an image using light from the backlight unit to the backlight unit, the panel mounting process comprising:
removing the protective member bonded to the backlight unit to uncover the second fixing surfaces of the fixing members; and
bonding the display panel to the second fixing surfaces to bond the display panel to the backlight unit with the fixing members.

2. The method of producing a display device according to claim 1, wherein the protective member includes a projecting portion that projects outward from a section of the peripheral edge.

3. The method of producing a display device according to claim 1, wherein
the light exiting surface of the backlight unit has a polygonal shape, and
the fixing member placing process comprises placing the fixing members on sides of the light exiting surface, respectively.

4. The method of producing a display device according to claim 1, further comprising a protective tray setting process for setting the backlight unit in a protective tray for protecting the light exiting surface after the fixing member placing process, wherein
the protective tray includes sidewall surfaces opposed to end surfaces of peripheral edges of the backlight unit, and
the protective tray setting process comprises:
providing a storage space defined by the sidewall surfaces and the protective member for holding the backlight unit; and
setting the backlight unit in the protective tray.

5. The method of producing a display device according to claim 4, wherein
the protective tray setting process comprises setting a plurality of the backlight units in the protective tray to collectively store the plurality of the backlight units in the protective tray such that the protective members bonded to the backlight units are separated from one another.

6. The method of producing a display device according to claim 5, wherein
the protective tray includes:
a bottom portion on which the plurality of the backlight units are placed; and
thick portions having a thickness greater than a thickness of the bottom portion, being arranged between the plurality of the backlight units, and including the sidewall surfaces.

7. The method of producing a display device according to claim 4, wherein
the protective tray includes bosses that protrude to an opposite side from the backlight unit to which the protective member is bonded and stored in the protective tray relative to the protective member, and
the protective tray setting process comprises:
setting the backlight units in a plurality of the protecting trays; and
placing the plurality of the protective trays on top of one another such that the boss of one of the protective trays is opposed to another one of the protective trays.

8. A backlight unit package comprising:
a backlight unit including a light exiting surface;
fixing members for bonding a display panel to the backlight unit, the fixing members having an elongated shape, including first fixing surfaces and second fixing surfaces, being disposed with longitudinal directions along peripheral edges of the light exiting surface of the backlight unit and with a gap between ends of the fixing members, wherein the first fixing surfaces are bonded to the peripheral edges of the light exiting surface; and
a protective member for protecting the light exiting surface of the backlight unit, the protective member being bonded to the second fixing surfaces of the fixing members such that a peripheral edge of the protective member in a form of a canopy extends outward from the peripheral edge of the light exiting surface at least at a position corresponding to the gap between the fixing members.
